(19) United States
(12) Patent Application Publication
(10) Pub. No.: US 2024/0243359 A1
(43) Pub. Date: Jul. 18, 2024

(54) ELECTROLYTE FOR RECHARGEABLE LITHIUM BATTERIES AND RECHARGEABLE LITHIUM BATTERIES

(71) Applicant: SAMSUNG SDI CO., LTD., Yongin-si (KR)

(72) Inventors: Harim LEE, Yongin-si (KR); Yunhee KIM, Yongin-si (KR); Arum YU, Yongin-si (KR); Tae Hyon BAE, Yongin-si (KR); Sanghyung KIM, Yongin-si (KR); Seunghyeon SON, Yongin-si (KR); Sundae KIM, Yongin-si (KR); Yeji YANG, Yongin-si (KR)

(21) Appl. No.: 18/488,857

(22) Filed: Oct. 17, 2023

(30) Foreign Application Priority Data
Dec. 29, 2022 (KR) 10-2022-0189450

(51) Int. Cl. H01M 10/0567; H01M 4/525; H01M 10/0569

(52) U.S. Cl. CPC H01M 10/0567; H01M 4/525; H01M 10/0569; H01M 2004/021; H01M 2300/0042

(57) ABSTRACT

An electrolyte for a rechargeable lithium battery including a non-aqueous organic solvent, a lithium salt, and an additive, wherein the additive includes a first compound represented by Chemical Formula 1, CsPF₆, or a combination thereof and a second compound that is represented by Chemical Formula 2-1, Chemical Formula 2-2, or a combination thereof. The chemical formulas and their definitions are as described in the specification.

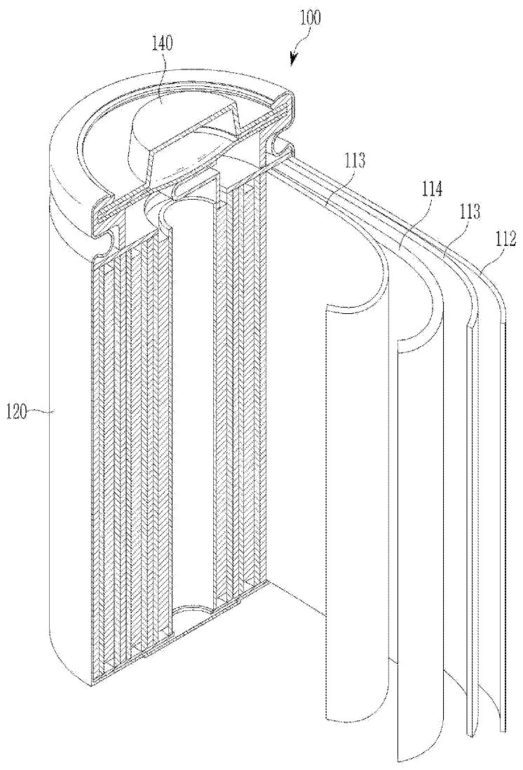

### CROSS-REFERENCE TO RELATED APPLICATION

This application claims priority to and the benefit of Korean Patent Application No. 10-2022-0189450, filed in the Korean Intellectual Property Office on Dec. 29, 2022, the entire content of which is incorporated herein by reference.

### BACKGROUND

### 1. Field

One or more aspects of embodiments of the present disclosure relate to an electrolyte for rechargeable lithium batteries and a rechargeable lithium battery including the electrolyte.

### 2. Description of the Related Art

A rechargeable lithium battery is widely utilized as a driving power source for mobile information terminals such as smart phones and laptops because it is easy to carry while providing (implementing) high energy density. Rechargeable lithium batteries may also now be configured for high capacity, high energy density, and high safety are being developed and actively studied for utilization as a power source for driving a hybrid vehicle or an electric vehicle, or as a power source for power storage.

In a rechargeable lithium battery, an electrolyte plays an important role in delivering lithium ions, and among them, an electrolyte including an organic solvent and a lithium salt is most commonly utilized because it can exhibit extremely high ionic conductivity. The electrolyte also plays an important role in determining safety and performance of the rechargeable lithium battery.

Batteries configured for high-capacity and high-energy density are desired or required to be designed to be driven at a high voltage (e.g., 4.5 V or more). Electrodes that can be operated at high density conditions are also desired or required. However, under severe conditions such as a high voltage or high-speed charging, a positive electrode may be deteriorated. For example, lithium dendrites may grow on the surface of the negative electrode to accelerate undesired reaction(s) of the electrodes and the electrolyte. There are also battery safety concerns related to a decrease in a battery cycle-life, gas generation, and/or the like.

Methods/designs of protecting the electrodes through a surface treatment to suppress or reduce the undesired reaction(s) of the electrodes and the electrolyte have been introduced. However, these methods/designs have reported that the surface treatment of the positive electrode exhibits insufficient protection under high voltage driving conditions, while the surface treatment of the negative electrode deteriorates capacity.

The need or desire thus exists for a high-capacity electrode drivable at a high voltage along with an electrolyte capable of concurrently (e.g., simultaneously) improving the battery safety and performance.

### SUMMARY

One or more aspects of embodiments of the present disclosure are directed toward an electrolyte for a rechargeable lithium battery and a rechargeable lithium battery including the electrolyte. In an embodiment, the electrolyte is configured to enhance or increase the performance and/or reliability of a high-capacity and/or high-voltage battery system, e.g., enhance or improve the cycle-life characteristics and safety. In an embodiment, the electrolyte is configured to enhance or increase the performance and/or reliability at a low temperature, e.g., a temperature of about 5° C. to about 25° C., (e.g., about 15° C.).

One or more aspects of embodiments of the present disclosure relate to an electrolyte for a rechargeable lithium battery that includes a non-aqueous organic solvent, a lithium salt, and an additive. In an embodiment, the additive includes (i) a first compound that is a compound represented by Chemical Formula 1, CsPF₆, or a combination thereof, and (ii) a second compound that is a compound represented by Chemical Formula 2-1, a compound represented by Chemical Formula 2-2, or a combination thereof.

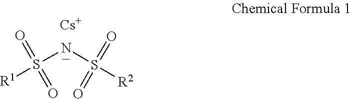

In Chemical Formula 1, R¹ and R² may each independently be a fluoro group or a C1 to C4 fluoroalkyl group substituted with at least one fluoro group.

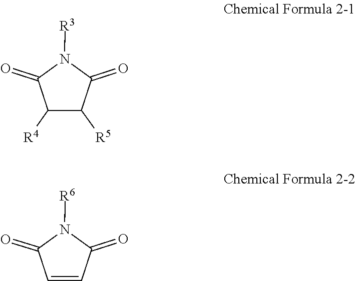

R³ in Chemical Formula 2-1 and R⁶ in Chemical Formula 2-2 may each independently be a substituted or unsubstituted C1 to C8 alkyl group, a substituted or unsubstituted C3 to C10 cycloalkyl group, a substituted or unsubstituted C6 to C12 aryl group, a substituted or unsubstituted C1 to C8 alkoxy group, a substituted or unsubstituted C1 to C8 alkoxycarbonyl group, a halogen group, a cyano group, a hydroxy group, or a thiol group.

In Chemical Formula 2-1, R⁴ and R⁵ may each independently be hydrogen, a substituted or unsubstituted C1 to C8 alkyl group, a substituted or unsubstituted C3 to C10 cycloalkyl group, a substituted or unsubstituted C6 to C12 aryl group, a substituted or unsubstituted C1 to C8 alkoxy group, a substituted or unsubstituted C1 to C8 alkoxycarbonyl group, a halogen group, a cyano group, a hydroxy group, or a thiol group.

One or more aspects of embodiments of the present disclosure relate to a rechargeable lithium battery including a positive electrode that has a positive electrode active material, a negative electrode that has a negative electrode active material, a separator between the positive electrode and the negative electrode, and the aforementioned electrolyte.

The rechargeable lithium battery according to an embodiment has enhanced or improved cycle-life characteristics and safety at a low temperature, such as about 5° C. to about 25° C., (e.g., about 15° C.), while implementing high-capacity and high-voltage characteristics.

Additional aspects will be set forth in part in the description which follows and, in part, will be apparent from the description, or may be learned by practice of the presented embodiments of the disclosure.

### BRIEF DESCRIPTION OF THE DRAWING

The accompanying drawing is included to provide a further understanding of the present disclosure, and is incorporated in and constitutes a part of this specification. The drawing illustrates an example embodiment, and facilitates explanation of the principles of the present disclosure, together with the detailed description.

The drawing is a schematic view illustrating a rechargeable lithium battery according to an embodiment.

### DETAILED DESCRIPTION

Hereinafter, specific embodiments will be described in more detail so that those of ordinary skill in the art can easily implement them. However, the present disclosure may be embodied in many different forms and is not construed as limited to the example embodiments set forth herein. The present disclosure may be modified in many alternate forms, and is intended to cover all modifications, equivalents, and alternatives falling within the spirit and scope of the present disclosure.

The terminology utilized herein describes embodiments only, and is not intended to limit the present disclosure. The singular expression includes the plural expression unless the context clearly dictates otherwise. Unless otherwise defined, all chemical names, technical and scientific terms, and terms defined in common dictionaries should be interpreted as having meanings consistent with the context of the related art, and should not be interpreted in an ideal or overly formal sense. It will be understood that, although the terms first, second, etc. may be used herein to describe various elements, these elements should not be limited by these terms. These terms are only used to distinguish one element from another element. Thus, a first element could be termed a second element without departing from the teachings of the present disclosure. Similarly, a second element could be termed a first element.

As utilized herein, “combination thereof” refers to a mixture, laminate, composite, copolymer, alloy, blend, reaction product, and/or the like of the constituents.

As utilized herein, terms such as “comprises,” “comprising,” “includes,” “including,” “having,” and/or “have” are intended to designate the presence of an embodied feature, number, step, element, or a combination thereof, but do not preclude the possibility of the presence or addition of one or more other features, number, step, element, or a combination thereof.

As used herein, singular forms such as “a,” “an,” and “the” are intended to include the plural forms as well, unless the context clearly indicates otherwise.

As used herein, the terms “use,” “using,” and “used” may be considered synonymous with the terms “utilize,” “utilizing,” and “utilized,” respectively.

As used herein, expressions such as “at least one of,” “one of,” and “selected from,” when preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

As used herein, the term “and/or” includes any and all combinations of one or more of the associated listed items.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item.

It will be understood that when an element is referred to as being “on,” “connected to,” or “coupled to” another element, it may be directly on, connected, or coupled to the other element or one or more intervening elements may also be present. When an element is referred to as being “directly on,” “directly connected to,” or “directly coupled to” another element, there are no intervening elements present.

Spatially relative terms, such as “beneath,” “below,” “lower,” “above,” “upper,” “bottom,” “top,” and the like, may be used herein for ease of description to describe one element or feature's relationship to another element(s) or feature(s) as illustrated in the drawings. It will be understood that the spatially relative terms are intended to encompass different orientations of the device in use or operation in addition to the orientation depicted in the drawings. For example, if the device in the drawings is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

Unless otherwise defined, all terms (including technical and scientific terms) used herein have the same meaning as commonly understood by those of ordinary skill in the art to which the present disclosure pertains. It is also to be understood that terms defined in commonly used dictionaries should be interpreted as having meanings consistent with meanings in the context of the related art, unless expressly defined herein, and should not be interpreted in an ideal or overly formal sense.

In this context, “consisting essentially of” means that any additional components will not materially affect the chemical, physical, optical or electrical properties of the semiconductor film.

Further, in this specification, the phrase “on a plane,” or “plan view,” means viewing a target portion from the top, and the phrase “on a cross-section” means viewing a cross-section formed by vertically cutting a target portion from the side.

In the drawing, the thickness of layers, films, panels, regions, etc., are exaggerated for clarity and like reference numerals designate like elements throughout, and duplicative descriptions thereof may not be provided in the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In some embodiments, “layer” as utilized herein includes not only a shape formed on the whole surface when viewed from a plan view, but also a shape formed on a partial surface.

In some embodiments, the average particle diameter may be measured by a method well suitable to those skilled in the art, for example, may be measured by a particle size analyzer, or may be measured by an optical microscope image such as a transmission electron micrograph or a scanning electron micrograph. In some embodiments, it is possible to obtain an average particle diameter value by measuring utilizing a dynamic light scattering method, performing data analysis, counting the number of particles for each particle size range, and calculating from this. Unless otherwise defined, the average particle diameter may refer to the diameter (D50) of particles having a cumulative volume of 50 volume % in the particle size distribution.

Herein, “or” is not to be construed as an exclusive meaning, for example, “A or B” is construed to include A, B, A+B, and/or the like.

As utilized herein, unless otherwise defined, “substituted” refers to replacement of at least one hydrogen in a substituent or compound by deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, or a combination thereof.

For example, “substituted” refers to replacement of at least one hydrogen in a substituent or compound by deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, “substituted” refers to replacement of at least one hydrogen in a substituent or compound by deuterium, a halogen group, a C1 to C20 alkyl group, a C6 to C30 aryl group, a C1 to C10 fluoroalkyl group, or a cyano group. In some embodiments, “substituted” refers to replacement of at least one hydrogen in a substituent or compound by deuterium, a halogen group, a C1 to C5 alkyl group, a C6 to C18 aryl group, a C1 to C5 fluoroalkyl group, or a cyano group. For example, “substituted” refers to replacement of at least one hydrogen in a substituent or compound by deuterium, a cyano group, a halogen group, a methyl group, an ethyl group, a propyl group, a butyl group, a phenyl group, a biphenyl group, a terphenyl group, a trifluoromethyl group, or a naphthyl group.

Expressions such as C1 to C30 refer to that the number of carbon atoms is 1 to 30.

### Electrolyte

Aspects of one or more embodiments of the present disclosure relate to an electrolyte for a rechargeable lithium battery that includes a non-aqueous organic solvent, a lithium salt, and an additive. In an embodiment, the additive includes (i) a first compound and (ii) a second compound.

In an embodiment, the first compound is a compound represented by Chemical Formula 1 as disclosed herein, CsPF₆, or a combination thereof.

In an embodiment, the second compound is a compound represented by Chemical Formula 2-1 as disclosed herein, a compound represented by Chemical Formula 2-2 as disclosed herein, or a combination thereof.

In an embodiment, the additive may be a combination that includes both (e.g., simultaneously) the first compound and the second compound. In an embodiment, the first compound includes (e.g., includes only) the compound represented by Chemical Formula 1. In an embodiment, the first compound includes both (e.g., simultaneously) of the compound represented by Chemical Formula 1 and CsPF₆ (e.g., a mixture of two compounds).

In an embodiment, the second compound includes the compound represented by Chemical Formula 2-1. In an embodiment, the second compound includes (e.g., includes only) the compound represented by Chemical Formula 2-2. In an embodiment, the second compound includes both (e.g., simultaneously) of the compound represented by Chemical Formula 2-1 and the compound represented by Chemical Formula 2-2.

The electrolyte may enhance or improve overall performance of the rechargeable lithium battery by forming a stable film at (e.g., on), an interface of an electrode and the electrolyte. In an embodiment, the stable film may be formed during operation of the battery. In an embodiment, the electrolyte may enhance or improve the safety and cycle-life characteristics of the battery, (e.g., a battery that is designed for high capacity and high voltage). In an embodiment, the electrolyte may have an excellent or suitable effect of enhancing or improving the low-temperature cycle-life characteristics. In embodiments in which the additive includes both (e.g., simultaneously) the first and second compounds as the additive (e.g., as compared with a case of including neither first compound nor second compound or just either one thereof), the electrolyte may enhance or improve the low-temperature cycle-life characteristics of the battery and in addition, control gas generation inside the battery according to charging and discharging and thus have an excellent or suitable effect of improving the safety.

### Additives

The first compound may be referred to as a cesium sulfonylimide salt or a cesium fluorinated sulfonylimide salt and may be represented by Chemical Formula 1:

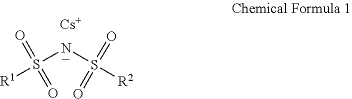

In Chemical Formula 1, R¹ and R² may each independently be a fluoro group or a C1 to C4 fluoroalkyl group substituted with at least one fluoro group. The term “fluoro group” as utilized herein, refers to a substituent that may be —F, —CH₂F, —CHF₂, or —CF₃, or a combination thereof.

For example, in Chemical Formula 1, R¹ and R² may each independently be a fluoro group or a C1 to C4 fluoroalkyl group substituted with at least two fluoro groups. In some embodiments, R¹ and R² may each independently be a fluoro group or a C1 to C4 fluoroalkyl group substituted with at least three fluoro groups. For example, R¹ and R² may each independently be a fluoro group or a C1 to C3 fluoroalkyl group substituted with at least three fluoro groups. In some embodiments, R¹ and R² may each independently be a fluoro group or a C1 to C2 fluoroalkyl group substituted with at least three fluoro groups.

The first compound may be decomposed in the electrolyte even under high voltage conditions to form a stable film at (e.g., on), the surface of the electrode. The electrolyte and/or stable film may effectively control the elution of lithium ions from the electrode to prevent or reduce electrode decomposition. For example, the first compound may be reduced and/or decomposed in the presence of non-aqueous organic solvents, such as carbonate-based solvents, to form a solid-electrolyte-interface (SEI) film at the interface between the negative electrode and the electrolyte. The SEI film may prevent or reduce decomposition of the electrolyte and/or the electrode, and/or suppress an increase in battery internal resistance due to gas generation. It is understood that the SEI film is partially decomposed through a reduction reaction during charging and discharging and moves to the surface of the positive electrode to form a film at the interface between the positive electrode and the electrolyte through an oxidation reaction, thereby preventing or reducing the decomposition of the positive electrode surface and the oxidation reaction of the electrolyte.

For example, the compound represented by Chemical Formula 1 may be represented by Chemical Formula 1-1 or 1-2.

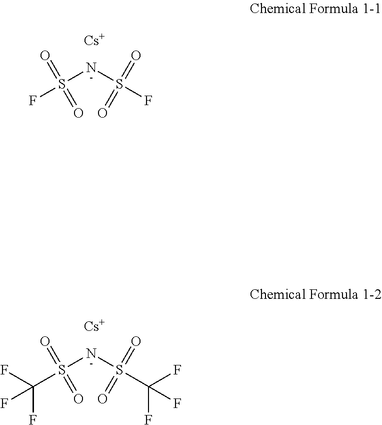

In an embodiment, the first compound may be included in an amount of about 0.01 part by weight to about 1.9 parts by weight, for example, about 0.05 parts by weight to about 1.7 parts by weight, about 0.1 parts by weight to about 1.5 parts by weight, about 0.1 parts by weight to about 1.3 parts by weight, about 0.1 parts by weight to about 1.0 part by weight, about 0.1 parts by weight to about 0.7 parts by weight, or about 0.01 parts by weight to about 1.0 parts by weight, based on 100 parts by weight of a total amount of the non-aqueous organic solvent and the lithium salt. In an embodiment, content (e.g., amount) of the first compound within these ranges may be associated with enhanced or improved low-temperature cycle-life characteristics and/or safety of the battery without adversely affecting the overall performance of the battery. For example, when the content (e.g., amount) of the first compound is excessive, e.g., about two or more times greater than as disclosed herein, low-temperature cycle-life characteristics may be deteriorated and/or the amount of gas generated in the battery may increase, resulting in safety problems.

The second compound may be a compound represented by Chemical Formula 2-1 or a compound represented by Chemical Formula 2-2, or a combination thereof. The compound represented by Chemical Formula 2-1 may be referred to as a succinimide derivative, and the compound represented by Chemical Formula 2-2 may be referred to as a maleimide derivative. The second compound may lead to the formation of a stable SEI film even under high-capacity and high-voltage conditions, and may contribute to enhancing or improving battery life characteristics and reducing gas generation in the battery even at low temperatures, such as about 5° ° C. to about 25° C., (e.g., about 15° C.).

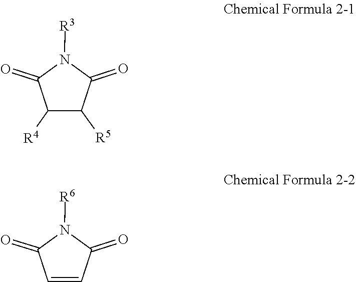

R³ in Chemical Formula 2-1 and R⁶ in Chemical Formula 2-2 may each independently be a substituted or unsubstituted C1 to C8 alkyl group, a substituted or unsubstituted C3 to C10 cycloalkyl group, a substituted or unsubstituted C6 to C12 aryl group, a substituted or unsubstituted C1 to C8 alkoxy group, a substituted or unsubstituted C1 to C8 alkoxycarbonyl group, a halogen group, a cyano group, a hydroxy group, or a thiol group.

In Chemical Formula 2-1, R⁴ and R⁵ may each independently be hydrogen, a substituted or unsubstituted C1 to C8 alkyl group, a substituted or unsubstituted C3 to C10 cycloalkyl group, a substituted or unsubstituted C6 to C12 aryl group, a substituted or unsubstituted C1 to C8 alkoxy group, a substituted or unsubstituted C1 to C8 alkoxycarbonyl group, a halogen group, a cyano group, a hydroxy group, or a thiol group.

R³ in Chemical Formula 2-1 and R⁶ in Chemical Formula 2-2 are functional groups bonded to nitrogen, and may be, for example, a substituted or unsubstituted C1 to C8 alkyl group, a substituted or unsubstituted C3 to C10 cycloalkyl group, a substituted or unsubstituted C1 to C8 alkoxy group, or a substituted or unsubstituted C1 to C8 alkoxycarbonyl group. In an embodiment, R³ in Chemical Formula 2-1 and R⁶ in Chemical Formula 2-2 may each independently be a substituted or unsubstituted C1 to C8 alkyl group or a substituted or unsubstituted C3 to C10 cycloalkyl group.

The C1 to C8 alkyl group may be, for example, a C1 to C7 alkyl group, a C1 to C6 alkyl group, a C1 to C5 alkyl group, or a C1 to C4 alkyl group.

For example, R³ in Chemical Formula 2-1 and R⁶ in Chemical Formula 2-2 may each independently be methyl, ethyl, n-propyl, isopropyl, cyclopropyl, n-butyl, see-butyl, isobutyl, tert-butyl, cyclobutyl, methoxy, ethoxy, propoxy, or butoxy. In an embodiment, the second compound may enhance or improve the low-temperature cycle-life characteristics of the high-voltage and high-output batteries without adversely affecting the overall performance of the battery.

In Chemical Formula 2-1, R⁴ and R⁵ are substituted functional groups in a ring, and may be, for example, hydrogen, a substituted or unsubstituted C1 to C8 alkyl group, a halogen group, a cyano group, a hydroxyl group, or a thiol group. In an embodiment, R⁴ and R⁵ may each independently be hydrogen, a substituted or unsubstituted C1 to C5 alkyl group, or a thiol group.

For example, Chemical Formula 2-1 may be represented by Chemical Formula 2-1A, and Chemical Formula 2-2 may be represented by Chemical Formula 2-2A. These compounds are excellent or suitable in improving low-temperature characteristics of high-voltage and high-output batteries.

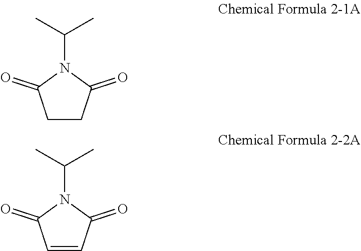

The second compound may be included in an amount of about 0.1 parts by weight to about 4.9 parts by weight, for example about 0.1 parts by weight to about 4 parts by weight, about 0.1 parts by weight to about 3 parts by weight, or about 0.1 parts by weight to about 2 parts by weight based on 100 parts by weight of the total amount of the non-aqueous organic solvent and the lithium salt. In an embodiment, the electrolyte may form a stable SEI film to enhance or improve overall performance of the battery, enhance or improve battery cycle-life characteristics at low temperatures, and/or effectively control the amount of gas generated in the battery. For example, when the content (e.g., amount) of the second compound is about two or more times greater than as disclosed herein, the battery may become unstable or unreliable due to an excessive amount of gas generated in the battery according to charging and discharging.

A weight ratio of the first compound to the second compound may be, for example, about 1:1 to about 1:20, about 1:1 to about 1:16, about 1:1 to about 1:12, or about 1:2 to about 1:10. In an embodiment, the disclosed ratios of the two compounds may be associated with enhanced or improved cycle-life characteristics of the battery at low temperatures, and/or a suppressed or reduced amount of gas generated in the battery.

The additive of the present disclosure may further include a third compound represented by Chemical Formula 3 in addition to the first compound and the second compound. The third compound may be referred to as a cesium fluorinated sulfonylimide salt, and has a different structural formula from the first compound. The compound represented by Chemical Formula 3 may decompose in the electrolyte during battery operation to form a stable film on the surface of the electrode, and/or may effectively control the elution of lithium ions from the electrode.

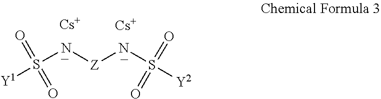

In Chemical Formula 3, Z is C(═O) or S(═O)₂, and Y¹ and Y² may each independently be a fluoro group or a C1 to C5 fluoroalkyl group substituted with at least one fluoro group.

In an embodiment, the C1 to C5 fluoroalkyl group substituted with at least one fluoro group may be, for example, a C1 to C5 fluoroalkyl group substituted with at least two fluoro groups, or a C1 to C5 fluoroalkyl group substituted with at least three fluoro groups, and the C1 to C5 fluoroalkyl group may be, for example, a C1 to C4 fluoroalkyl group, a C1 to C3 fluoroalkyl group, or a C1 to C2 fluoroalkyl group. In an embodiment, the fluoro group may be —F, —CH₂F, —CHF₂, or —CF₃.

The third compound may be, for example, represented by any one of Chemical Formulas 3-1 to 3-8.

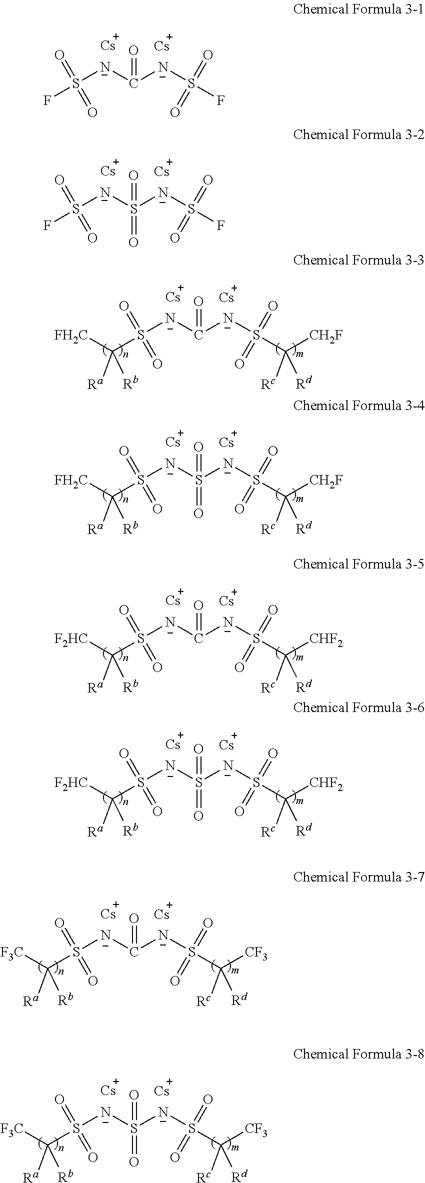

In Chemical Formulas 3-3 to 3-8, R^{a}, R^{b}, R^{c}, and R^{d} may each independently be hydrogen or a fluoro group, and n and m may each independently be an integer of 0 or 4. For example, n and m may each independently be 0, 1, or 2.

The third compound may be included in an amount of about 0.01 parts by weight to about 5 parts by weight, for example about 0.05 parts by weight to about 4.0 parts by weight, about 0.1 parts by weight to about 3.0 parts by weight, about 0.1 parts by weight to about 4.0 parts by weight, about 0.1 parts by weight to about 1.0 part by weight, or about 0.1 parts by weight to about 0.7 parts by weight based on 100 parts by weight of the total amount of the non-aqueous organic solvent and the lithium salt. In an embodiment, content (e.g., amount) of the third compound within these ranges, may be associated with enhanced or improved voltage resistance and oxidation resistance stability of the electrolyte without adversely affecting the overall performance of the battery, and/or enhanced or improved low-temperature performance of a battery designed for high capacity and high voltage.

In an embodiment, the electrolyte may include other additives in addition to the aforementioned additives. In an embodiment, the other additives may include at least one selected from vinylene carbonate (VC), fluoroethylene carbonate (FEC), difluoroethylene carbonate (DFEC), chloroethylene carbonate (CEC), dichloroethylene carbonate (DCEC), bromoethylene carbonate (BEC), dibromoethylene carbonate (DBEC), nitroethylene carbonate, cyanoethylene carbonate, vinylethylene carbonate (VEC), succinonitrile (SN), adiponitrile (AN), 1,3,6-hexane tricyanide (HTCN), propene sultone (PST), propane sultone (PS), lithium tetrafluoroborate (LiBF₄), lithium difluorophosphate (LiPO₂F₂), 2-fluoro biphenyl (2-FBP), and a combination thereof.

In an embodiment, including the other additives may be associated with enhanced or improved high-temperature and/or low-temperature storage characteristics. For example, effective control of the gas generated from the positive electrode and the negative electrode.

The other additives may be included in an amount of about 0.1 part by weight to about 20 parts by weight, for example, for example about 0.2 parts by weight to about 15 parts by weight, or about 0.5 parts by weight to about 10 parts by weight based on 100 parts by weight of the total amount of the non-aqueous organic solvent and the lithium salt. In an embodiment, the disclosed amounts of the other additives may be associated with enhanced or improved safety and/or cycle-life characteristics of the rechargeable lithium battery. For example, effective control of the gas generated from an electrode without adversely affecting the overall performance of the battery.

### Non-Aqueous Organic Solvent

The non-aqueous organic solvent serves as a medium through which ions involved in the electrochemical reaction of the battery may be transferred. As the non-aqueous organic solvent, a carbonate-based solvent, an ester-based solvent, an ether-based solvent, a ketone-based solvent, an alcohol-based solvent, an aprotic solvent, or a combination thereof may be utilized.

In an embodiment, the non-aqueous organic solvent may include a carbonate-based solvent and/or an ester-based solvent. For example, the non-aqueous organic solvent may include a carbonate-based solvent and a C1 to C8 alkyl propionate. In an embodiment, the electrolyte may possess excellent or suitable voltage resistance and oxidation resistance stability, and may be suitable for utilization in the aforementioned high-capacity, high-voltage electrode design.

The carbonate-based solvent may include, for example, dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or a combination thereof.

The ester-based solvent may include, for example, methyl acetate, ethyl acetate, n-propyl acetate, dimethyl acetate, methyl propionate, ethyl propionate, propyl propionate, butyl propionate, γ-butyrolactone, decanolide, valerolactone, mevalonolactone, caprolactone, and/or a combination thereof.

The ether-based solvent may include, for example, dibutyl ether, tetraglyme, diglyme, dimethoxyethane, 2-methyltetrahydrofuran, tetrahydrofuran, and/or a combination thereof.

The ketone-based solvent may be, for example, cyclohexanone, and the alcohol-based solvent may include, for example, ethyl alcohol, isopropyl alcohol, and/or a combination thereof. The aprotic solvent may include, for example nitrile(s) such as R—CN (wherein, R is a C2 to C20 linear, branched, or cyclic hydrocarbon group and may include a double bond, an aromatic ring, or an ether bond), and/or the like, amides such as dimethyl formamide, and/or the like, dioxolane(s) such as 1,3-dioxolane, and/or the like, and/or a combination thereof.

The non-aqueous organic solvent may be utilized alone or in a mixture. When the non-aqueous organic solvent is utilized in a mixture, the mixture ratio may be controlled or selected in accordance with a desirable battery performance.

In an embodiment, the non-aqueous organic solvent includes the carbonate-based solvent and the ester-based solvent. In an embodiment, the non-aqueous organic solvent includes about 10 volume % to about 60 volume % of the carbonate-based solvent and about 40 volume % to about 90 volume % of the ester-based solvent, based on 100 volume % of the carbonate-based solvent and the ester-based solvent. In an embodiment, the composition of the non-aqueous organic solvent disclosed herein may be associated with enhanced or improved voltage resistance and/or oxidation resistance stability of the electrolyte in a high-capacity high-voltage battery system.

In some embodiments, the carbonate-based solvent may include a cyclic carbonate and a chain carbonate. In some embodiments, the cyclic carbonate and the chain carbonate are mixed in a volume ratio of about 1:1 to about 1:9. In an embodiment, the disclosed ratio of the cyclic carbonate and the chain carbonate may be associated with enhanced or improved overall performance of the electrolyte.

The non-aqueous organic solvent may further include an aromatic hydrocarbon-based organic solvent in addition to the carbonate-based solvent. In this case, the carbonate-based solvent and the aromatic hydrocarbon-based organic solvent may be mixed in a volume ratio of about 1:1 to about 30:1.

The aromatic hydrocarbon-based solvent may be, for example, a compound represented by Chemical Formula I.

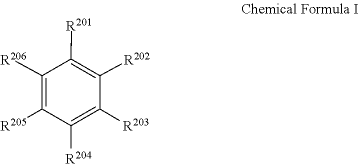

In Chemical Formula I, R²⁰¹ to R²⁰⁶ may each independently be the same or different and are selected from hydrogen, a halogen group, a C1 to C10 alkyl group, and a C1 to C10 haloalkyl group.

The aromatic hydrocarbon-based solvent may include, for example, benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and/or a combination thereof.

The electrolyte may further include a cycle-life improving additive. In an embodiment, the cycle-life improving additive may be a vinylene carbonate or an ethylene carbonate-based compound of Chemical Formula II

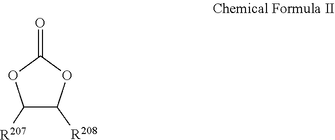

In Chemical Formula II, R²⁰⁷ and R²⁰⁸ may each independently be the same or different, and are selected from hydrogen, a halogen group, a cyano group, a nitro group, and a fluorinated C1 to C5 alkyl group. At least one of R²⁰⁷ and R²⁰⁸ is selected from a halogen group, a cyano group, a nitro group, and a fluorinated C1 to C5 alkyl group, but both (e.g., simultaneously) of R²⁰⁷ and R²⁰⁸ are not concurrently (e.g., simultaneously) hydrogen.

Examples of the ethylene carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, and/or fluoroethylene carbonate.

In an embodiment, the cycle-life improving additive may be utilized within an appropriate or suitable range.

### Lithium Salt

The lithium salt dissolved in the non-aqueous organic solvent supplies lithium ions in the rechargeable lithium battery, enables a basic operation of the rechargeable lithium battery, and improves transportation of the lithium ions between positive and negative electrodes.

Examples of the lithium salt include at least one selected from LiPF₆, LiBF₄, LiSbF₆, LiAsF₆, LIN(SO₂C₂F₅)₂, Li(CF₃SO₂)₂N, LIN(SO₃C₂F₅)₂, Li(FSO₂)₂N (lithium bis(fluorosulfonyl)imide, LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), (wherein x and y are natural numbers, for example, an integer of 1 to 20), lithium difluoro(bisoxalato) phosphate, LiCl, LiI, LiB(C₂O₄)₂ (lithium bis(oxalato) borate, LiBOB), and lithium difluoro(oxalato)borate (LiDFOB).

The lithium salt may be utilized in a concentration of about 0.1 M to about 2.0 M. In an embodiment, the lithium salt concentration within this range may be associated with an electrolyte having excellent or suitable performance and/or lithium ion mobility due to optimal or suitable electrolyte conductivity and viscosity.

### Rechargeable Lithium Battery

Aspects of one or more embodiments of the present disclosure relate to a rechargeable lithium battery. In an embodiment, the rechargeable lithium battery includes a positive electrode, a negative electrode, a separator, and the aforementioned electrolyte as disclosed elsewhere herein. In an embodiment, the positive electrode includes a positive electrode active material. In an embodiment, the negative electrode includes a negative electrode active material. In an embodiment, the separator is between (e.g., located between), the positive electrode and the negative electrode. The aforementioned electrolyte is suitable for application to a high-capacity, high-voltage, or high-output battery, and the rechargeable lithium battery may be referred to as a 4.5 V class high-voltage rechargeable lithium battery.

Referring to the drawing, the rechargeable lithium battery 100 includes a battery cell that includes a positive electrode 114, a negative electrode 112 facing the positive electrode 114, a separator 113 between the positive electrode 114 and the negative electrode 112. In an embodiment, an electrolyte is immersed in or is impregnated in the positive electrode 114 and/or the negative electrode 112. The rechargeable lithium battery 100 includes a battery case 120 containing the battery cell, and a sealing member 140 sealing the battery case 120.

### Positive Electrode

The positive electrode 114 may include a current collector and a positive electrode active material layer at (e.g., on), the current collector. The positive electrode active material layer may include a positive electrode active material. In an embodiment, the positive electrode active material layer may include a first binder and/or a conductive material.

### Positive Electrode Active Material

The positive electrode active material according to an embodiment may include a lithium cobalt-based oxide. The lithium cobalt-based oxide may be an oxide including lithium and cobalt. In an embodiment, the lithium cobalt-based oxide may include other elements in addition to lithium and cobalt. The positive electrode active material including lithium cobalt-based oxide may be configured to achieve high capacity and high initial charge/discharge efficiency, may be suitable for high voltage and high-speed charging, and/or may exhibit excellent or suitable resistance characteristics, high-temperature performance, and/or cycle-life characteristics when utilized together with the electrolyte described elsewhere herein.

In an embodiment, the lithium cobalt-based oxide may be represented by Chemical Formula 4.

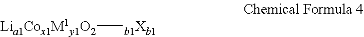

In Chemical Formula 4, 0.9≤a1≤1.8, 0.7≤x1≤1, 0≤y1≤0.3, 0.9≤x1+y1≤1.1, 0≤b1≤0.1, M¹ is at least one element selected from Al, B, Ba, Ca, Ce, Cr, Cu, Fe, Mg, Mn, Mo, Ni, Se, Si, Sr, Ti, V, W, Y, Zn, and Zr, and X is at least one element selected from F, P, and S.

In Chemical Formula 4, x1 may be 0.8≤x1≤1, 0.9≤x1≤1, or 0.95≤x1<1. In an embodiment, M¹ may be at least one element selected from Al, Ca, Ce, Cr, Cu, Fe, Mg, Mo, Se, Sr, Ti, V, W, Y, Zn, and Zr. M¹ may enhance or increase the structural stability of the lithium cobalt-based oxide at high voltage. In an embodiment, M¹ may suppress or reduce structural change or collapse of the positive electrode and/or the lithium cobalt-based oxide due to movement of lithium ions.

The positive electrode active material may be in the form of particles (in particle form) including lithium cobalt-based oxide, and may be, for example, in the form of secondary particles in which a plurality of primary particles made of lithium cobalt-based oxide are aggregated. The secondary particles may have an average particle diameter (D50) of about 1 μm to about 30 μm. Herein, also, the average particle diameter (D50) is measured by a particle size analyzer and may refer to a diameter of particles whose cumulative volume is 50 volume % in the particle size distribution.

For example, the positive electrode active material may have a bimodal form in which large particles and small particles are mixed. In an embodiment, the positive electrode active material includes a first positive electrode active material that includes particles (e.g., first or large particles), that include a lithium cobalt-based oxide and have an average particle diameter (D50) of about 9 μm to about 25 μm. In an embodiment, the positive electrode active material includes a second positive electrode active material that includes particles (e.g., second or small particles), that include a lithium cobalt-based oxide and have an average particle diameter (D50) of about 1 μm to about 8 μm. In an embodiment, the first positive electrode active material may be included in an amount of about 60 wt % to about 90 wt %, and the second positive electrode active material may be included in an amount of about 10 wt % to about 40 wt %, based on the total amount of first positive electrode active material and the second positive electrode active material. In an embodiment, the positive electrode including the positive electrode active material described herein may be configured to achieve high capacity and high energy density.

### First Binder

In an embodiment, the positive electrode includes a first binder. The first binder is configured to unite or aggregate the positive electrode active material (i.e., lithium cobalt-based oxide particles). In an embodiment, the first binder is configured to adhere the positive electrode active material to the current collector. Examples of the first binder may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but are not limited thereto.

The content (e.g., amount) of the first binder in the positive electrode active material layer may be approximately about 0.1 wt % to about 5 wt %, based on the total weight of the positive electrode active material layer.

### Conductive Material

The conductive material is included to provide electrode conductivity and any electrically conductive material may be used utilized as a conductive material unless it causes a chemical change. Examples of the conductive material may include a carbon-based material such as natural graphite, artificial graphite, carbon black, acetylene black, ketjen black, a carbon fiber, carbon nanofiber, carbon nanotube, and/or the like; a metal-based material of a metal powder or a metal fiber including copper, nickel, aluminum, silver, and/or the like; a conductive polymer such as a polyphenylene derivative; or a mixture thereof.

The content (e.g., amount) of the conductive material in the positive electrode active material layer may be about 1 wt % to about 5 wt % based on the total weight of the positive electrode active material layer.

### Negative Electrode

The negative electrode 112 may include a current collector and a negative electrode active material layer at (e.g., on), the current collector. The negative electrode active material layer may include a negative electrode active material. In an embodiment, the negative electrode active material layer may include a second binder and/or a conductive material.

### Negative Electrode Active Material

In an embodiment, the negative electrode active material may include a material that reversibly intercalates/deintercalates lithium ions, a lithium metal, a lithium metal alloy, a material capable of doping/dedoping lithium, and/or a transition metal oxide.

In an embodiment, the material that reversibly intercalates/deintercalates lithium ions may include a carbon-based negative electrode active material. For example, the carbon-based negative electrode active material may be a crystalline carbon, an amorphous carbon, or a combination thereof. The crystalline carbon may be irregular-shaped, plate-like, flake-like, spherical, or fiber-shaped natural graphite or artificial graphite and the amorphous carbon may be a soft carbon, a hard carbon, a mesophase pitch carbonization product, calcined coke, and/or the like.

The lithium metal alloy includes lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. In an embodiment, the Si-based negative electrode active material may include silicon, a silicon-carbon composite, SiOₓ (0<x<2), and/or a Si-Q alloy (wherein Q is an alkali metal, an alkaline-earth metal, a Group 13 element, a Group 14 element, a Group 15 element, a Group 16 element, a transition metal, a rare earth element, or a combination thereof, but not Si). In an embodiment, the Sn-based negative electrode active material may include Sn, SnO₂, and/or an Sn—R alloy (wherein R is an alkali metal, an alkaline-earth metal, a Group 13 element, a Group 14 element, a Group 15 element, a Group 16 element, a transition metal, a rare earth element, or a combination thereof, but not Sn). In an embodiment, the Sn-based negative electrode active material may be mixed with SiO₂. The elements Q and R may be (e.g., may each be) selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

In an embodiment, the silicon-carbon composite of the Si-based negative electrode active material may be in the form of particles. An average particle diameter (D50) of the particles included in the silicon-carbon composite may be, for example, about 0.5 μm to about 20 μm. Herein, the average particle diameter (D50) is measured by a particle size analyzer and may refer to a diameter of particles whose cumulative volume is about 50 volume % in the particle size distribution. The silicon may be included in an amount of about 10 wt % to about 60 wt % and the carbon may be included in an amount of about 40 wt % to about 90 wt %, based on 100 wt % of the silicon-carbon composite particle.

In an embodiment, the silicon-carbon composite particle may include, for example, a core containing silicon particles and a carbon coating layer on a surface of the core. An average particle diameter (D50) of the silicon particles in the core may be about 10 nm to about 1 μm, or about 10 nm to about 200 nm. The silicon particle may exist alone, in the form of a silicon alloy, or in an oxidized form. The oxidized form of silicon may be represented as SiOₓ (0<x<2). In some embodiments, the carbon coating layer may have a thickness of about 5 nm to about 100 nm.

For example, the silicon-carbon composite particle may include a core including silicon particles and crystalline carbon, and a carbon coating layer disposed on a surface of the core and including amorphous carbon. For example, in the silicon-carbon composite particle, the amorphous carbon may not exist in the core but only in the carbon coating layer.

In an embodiment, the crystalline carbon may be artificial graphite, natural graphite, or a combination thereof. In an embodiment, the amorphous carbon may be coal-based pitch, mesophase pitch, petroleum-based pitch, coal-based oil, petroleum-based heavy oil, and/or a polymer resin (phenol resin, furan resin, polyimide resin, etc.). In an embodiment, a content (e.g., amount) of the crystalline carbon may be about 10 wt % to about 70 wt %, and a content (e.g., amount) of the amorphous carbon may be about 20 wt % to about 40 wt % based on 100 wt % of the silicon-carbon composite particle.

In the silicon-carbon composite particle, the core may include a void in the central portion. The radius of the void may be about 30% to about 50% by length of the radius of the silicon-carbon composite particle.

The aforementioned silicon-carbon composite particle is configured to effectively suppress or reduce volume expansion, structural collapse, and/or particle crushing due to charging and discharging. The aforementioned silicon-carbon composite particle is configured to prevent or reduce disconnection of the conductive path and is configured to achieve high capacity and high efficiency, and may be utilized under high-voltage or high-speed charging condition.

In an embodiment, the negative electrode active material may include both (e.g., simultaneously) the carbon-based negative electrode active material and the Si-based negative electrode active material. In this case, the Si-based negative electrode active material may be included in an amount of about 0.1 wt % to about 20 wt %, for example about 1 wt % to about 10 wt %, about 2 wt % to about 7 wt %, or about 2.5 wt % to about 5 wt %, based on a total amount of the carbon-based negative electrode active material and the silicon-based negative electrode active material. In this case, high capacity may be implemented and it is advantageous for high-voltage and high-speed charging.

### Second Binder

In an embodiment, the negative electrode includes a second binder. The second binder is configured to unite or aggregate the negative electrode active material particles to each other. In an embodiment, the second binder is configured to adhere the negative electrode active material to the current collector. The second binder may be a water-insoluble binder, a water-soluble binder, or a combination thereof.

Examples of the water-insoluble binder include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, and/or a combination thereof.

The water-soluble binder may be a rubber-based binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is utilized as the second binder, a cellulose-based compound capable of imparting viscosity may be further included as a type or kind of thickener. As the cellulose-based compound, one or more of carboxymethyl cellulose, hydroxypropylmethyl cellulose, methyl cellulose, and/or alkali metal salts thereof may be mixed and utilized. The alkali metal may be Na, K, and/or Li. The amount of the thickener utilized may be 0.1 parts by weight to about 3 parts by weight, based on about 100 parts by weight of the negative electrode active material.

A content (e.g., amount) of the second binder may be about 0.1 wt % to about 5 wt % based on 100 wt % of the negative electrode active material layer.

### Current Collector

The positive electrode current collector may include an aluminum foil, but is not limited thereto.

The negative electrode current collector may be selected from a copper foil, a nickel foil, a stainless steel foil, a titanium foil, a nickel foam, a copper foam, a polymer substrate coated with a conductive metal, and a combination thereof.

### Separator

Returning to the drawing, the separator 113 separates the positive electrode 114 and the negative electrode 112 and provides a transporting passage for lithium ions and may be any generally-utilized separator in a lithium ion battery. In other words, the separator 113 may have low resistance to ion transport and excellent or suitable impregnation for an electrolyte. For example, the separator 113 may include a glass fiber, polyester, polyethylene, polypropylene, polytetrafluoroethylene, or a combination thereof and may have a form of a non-woven fabric or a woven fabric. For example, in a lithium ion battery, a polyolefin-based polymer separator such as polyethylene and polypropylene is mainly utilized. In some embodiments, a coated separator having enhanced heat resistance and/or mechanical strength, (e.g., a ceramic component or a polymer material), may be utilized. In some embodiments, the separator 113 may have a mono-layered or multi-layered structure.

Rechargeable lithium batteries may be classified as lithium ion batteries, lithium ion polymer batteries, and lithium polymer batteries according to the presence of a separator and the type or kind of electrolyte utilized therein. The rechargeable lithium batteries may have a variety of shapes and sizes, and include cylindrical, prismatic, coin, or pouch-type or kind batteries, and may be thin film batteries or may be rather bulky in size. Structures and manufacturing methods for these batteries pertaining to this disclosure are well suitable in the art.

The rechargeable lithium battery according to an embodiment may be utilized in an electric vehicle (EV), a hybrid electric vehicle such as a plug-in hybrid electric vehicle (PHEV), and/or a portable electronic device. In an embodiment, the rechargeable lithium battery of the present disclosure is configured to achieve high capacity and has excellent or suitable storage stability, cycle-life characteristics, and high rate characteristics at high temperatures.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or +30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

In the present disclosure, when particles are spherical, “diameter” indicates an average particle diameter, and when the particles are non-spherical, the “diameter” indicates a major axis length. The diameter (or size) of the particles may be measured by particle size analysis, dynamic light scattering, scanning electron microscopy, and/or transmission electron microscope photography. When the size of the particles is measured utilizing a particle size analyzer, the average particle diameter (or size) may be referred to as D50. The term “D50” as utilized herein refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size. Particle size analysis may be performed with a HORIBA LA-950 laser particle size analyzer.

Hereinafter, examples of the present disclosure and comparative examples are described. However, the examples are for the purpose of illustration and are not to be construed as limiting the present disclosure.

### EXAMPLES

### Example 1

### (1) Manufacture of Positive Electrode

A first positive electrode active material (LiCo_{0.974}Al_{0.0210}Mg_{0.005}O₂) having an average particle diameter (D50) of about 20 μm and a second positive electrode active material (LiCo_{0.9823}Al_{0.0127}Mg_{0.005}O₂) having an average particle diameter (D50) of about 4 μm were mixed in a weight ratio of 8:2 to prepare a positive electrode active material.

95 wt % of the prepared positive electrode active material, 3 wt % of a polyvinylidene fluoride binder, and 2 wt % of a ketjen black conductive material were mixed in an N-methylpyrrolidone solvent to prepare a positive electrode active material slurry. The positive electrode active material slurry was coated on an aluminum current collector, dried, and then compressed to prepare a positive electrode.

### (2) Manufacture of Negative Electrode

A graphite negative electrode active material, a styrene-butadiene rubber binder, and carboxymethylcellulose were mixed in a weight ratio of 98:1:1, respectively, and dispersed in distilled water to prepare a negative electrode active material slurry. The negative electrode active material slurry was coated on a copper current collector, dried, and then compressed to manufacture a negative electrode.

### (3) Preparation of Electrolyte

Ethylene carbonate (EC), propylene carbonate (PC), ethyl propionate (EP), and propyl propionate (PP) were mixed in a volume ratio of 10:15:30:45 to prepare a non-aqueous organic solvent. LiPF₆ lithium salt was dissolved at a concentration of 1.3 M in the prepared non-aqueous organic solvent to prepare a basic electrolyte. The additives as 0.25 parts by weight of the compound represented by Chemical Formula 1-1 and 1 part by weight of the compound represented by Chemical Formula 2-2A (1-isopropyl-1H-pyrrole-2,5-dione) were added to 100 parts by weight of the basic electrolyte to prepare an electrolyte.

### (4) Manufacture of Rechargeable Lithium Battery Cell

A polyethylene polypropylene multilayer separator was disposed between the prepared positive electrode and negative electrode, the resultant assembly was inserted into a pouch cell, and then the prepared electrolyte was injected to manufacture a 4.5 V pouch-type or kind full cell.

### Example 2

An electrolyte and a rechargeable lithium battery cell was manufactured in substantially the same manner as in Example 1 except that the amount of the additive represented by Chemical Formula 2-2A was changed as shown in Table 1.

### Comparative Examples 1 to 6

Electrolytes and rechargeable lithium batteries were manufactured in substantially the same manner as in Example 1 except that the amounts of the additives represented by Chemical Formulae 2-1A and 2-2A were changed as shown in Table 1.

### Evaluation Example 1

### Evaluation Example 1: Evaluation of 15° C. Low-Temperature Cycle-Life Characteristics and Thickness Increase Rate of Battery Cell

The rechargeable lithium battery cells of Examples 1 to 2 and Comparative Examples 1 to 6 were charged to an upper limit of 4.5 V at 0.2 C (CC-CV mode, 0.02 C cut-off) at 15° C., paused for 10 minutes, and discharged to 2.75 V at 0.2 C (CC mode) to perform initial charge and discharge.

Subsequently, the cells were 400 times (or at least 400 times) charged under conditions of 2.0 C, 4.16 V (CC-CV, 1.4 C cut-off); 1.4 C, 4.32 V (CC-CV, 1.0 C cut-off); 1.0 C, 4.5 V (CC-CV, 0.02 C cut-off) and discharged to 3.0 V at 1.0 C (CC) to calculated a ratio of discharge capacity at the 400 cycles to the initial discharge capacity, and the results are shown as capacity retention in Table 1.

In some embodiments, a ratio of a battery thickness at the 400 cycles to a battery thickness right before the initial charge and discharge was calculated to obtain a thickness increase rate, which is shown in Table 1.

TABLE 1

| | Chemical | | Capacity | Thickness |
|---|---|---|---|---|
| | Formula 1-1 | Chemical | retention | increase rate |
| | (parts by | Formula 2-2A | @400 cyc | @400 cyc |
| | weight) | (wt %) | (%) | (%) |
| Comparative | 0 | 0 | 83.5 | 2.4 |
| Example 1 | | | | |
| Comparative | 0.25 | 0 | 85.3 | 3.6 |
| Example 2 | | | | |
| Comparative | 0.5 | 0 | 86.8 | 6.9 |
| Example 3 | | | | |
| Comparative | 0 | 1 | 86.9 | 8.9 |
| Example 4 | | | | |
| Example 1 | 0.25 | 1 | 88.4 | 2.6 |
| Example 2 | 0.25 | 2 | 88 | 2.4 |
| Comparative | 2 | 1 | 80.1 | 10.3 |
| Example 5 | | | | |
| Comparative | 0.25 | 5 | 77.8 | 13.2 |
| Example 6 | | | | |

Referring to Table 1, Comparative Example 1 utilized no additive and exhibited a battery thickness increase rate of 2.4% at 400 cycles. Comparative Examples 2 and 3, which utilized a single additive that is the first compound of Chemical Formula 1-1, exhibited a battery thickness increase rate according (e.g., in proportion) to the addition content (e.g., amount). Comparative Example 4, which utilized a single additive that is the second compound of Chemical Formula 2-2A, also exhibited a higher battery thickness increase rate compared with Comparative Example 1. On the other hand, Examples 1 and 2, utilized two additives, according to an embodiment of the present disclosure, and exhibited enhanced or improved low-temperature cycle-life characteristics, (e.g., higher capacity retention) compared with at least Comparative Examples 1-4, and a similar thickness increase rate as Comparative Example 1.

Comparative Example 5, in which the compound represented by Chemical Formula 1 was utilized in an amount of 2 wt % or more, and Comparative Example 6, in which the compound represented by Chemical Formula 2-2A was utilized in an amount of 5 wt % or more, exhibited a battery thickness increase rate of more than 10% and lower capacity retention compared to Comparative Examples 1-4. In contrast, Examples 1 and 2, in which the compound represented by Chemical Formula 1 was utilized in an amount of less than 2 wt %, and the compound represented by Chemical Formula 2-2A was utilized in an amount of less than 5 wt %, exhibited excellent or suitable effects of improving cycle-life characteristics (e.g., higher capacity retention) and reducing a thickness increase rate.

While this present disclosure has been described in connection with what is presently considered to be practical example embodiments, it is to be understood that the present disclosure is not limited to the disclosed embodiments. In contrast, it is intended to cover one or more suitable modifications and equivalent arrangements included within the spirit and scope of the following claims and equivalents thereof.

Description of Symbols

| | |
|---|---|
| 100: rechargeable lithium battery | 112: negative electrode |
| 113: separator | 114: positive electrode |
| 120: battery case | 140: sealing member |

What is claimed is:

1. An electrolyte for a rechargeable lithium battery, comprising
a non-aqueous organic solvent, a lithium salt, and an additive,
wherein the additive comprises:
(i) a first compound that is a compound represented by Chemical Formula 1, CsPF₆, or a combination thereof: 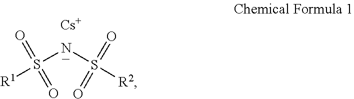
wherein, in Chemical Formula 1,
R¹ and R² are each independently a fluoro group or a C1 to C4 fluoroalkyl group substituted with at least one fluoro group; and
(ii) a second compound that is a compound represented by Chemical Formula 2-1, Chemical Formula 2-2, or a combination thereof: 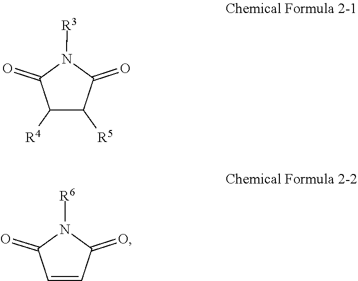
wherein R³ in Chemical Formula 2-1 and R⁶ in Chemical Formula 2-2 are each independently a substituted or unsubstituted C1 to C8 alkyl group, a substituted or unsubstituted C3 to C10 cycloalkyl group, a substituted or unsubstituted C6 to C12 aryl group, a substituted or unsubstituted C1 to C8 alkoxy group, a substituted or unsubstituted C1 to C8 alkoxycarbonyl group, a halogen group, a cyano group, a hydroxy group, or a thiol group, and
in Chemical Formula 2-1,
R⁴ and R⁵ are each independently hydrogen, a substituted or unsubstituted C1 to C8 alkyl group, a substituted or unsubstituted C3 to C10 cycloalkyl group, a substituted or unsubstituted C6 to C12 aryl group, a substituted or unsubstituted C1 to C8 alkoxy group, a substituted or unsubstituted C1 to C8 alkoxycarbonyl group, a halogen group, a cyano group, a hydroxy group, or a thiol group.

2. The electrolyte of claim 1, wherein
the compound represented by Chemical Formula 1 is represented by Chemical Formula 1-1 or 1-2:

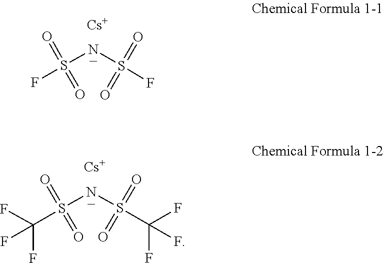

3. The electrolyte of claim 1, wherein
the first compound is in an amount of about 0.01 parts by weight to about 1.9 parts by weight based on 100 parts by weight of a total amount of the non-aqueous organic solvent and the lithium salt.

4. The electrolyte of claim 1, wherein
the first compound is in an amount of about 0.01 parts by weight to about 1.0 parts by weight based on 100 parts by weight of a total amount of the non-aqueous organic solvent and the lithium salt.

5. The electrolyte of claim 1, wherein
R³ in Chemical Formula 2-1 and R⁶ in Chemical Formula 2-2 are each independently a substituted or unsubstituted C1 to C8 alkyl group, a substituted or unsubstituted C3 to C10 cycloalkyl group, a substituted or unsubstituted C1 to C8 alkoxy group, or a substituted or unsubstituted C1 to C8 alkoxycarbonyl group.

6. The electrolyte of claim 1, wherein
R³ in Chemical Formula 2-1 and R⁶ in Chemical Formula 2-2 are each independently methyl, ethyl, n-propyl, isopropyl, cyclopropyl, n-butyl, see-butyl, isobutyl, tert-butyl, cyclobutyl, methoxy, ethoxy, propoxy, or butoxy.

7. The electrolyte of claim 1, wherein
Chemical Formula 2-1 is represented by Chemical Formula 2-1A and Chemical Formula 2-2 is represented by Chemical Formula 2-2A:

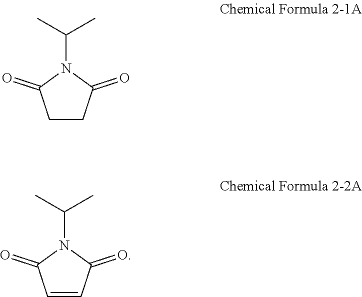

8. The electrolyte of claim 1, wherein
the second compound is in an amount of about 0.1 parts by weight to about 4.9 parts by weight based on 100 parts by weight of a total amount of the non-aqueous organic solvent and the lithium salt.

9. The electrolyte of claim 1, wherein
the second compound is in an amount of about 0.1 parts by weight to about 3 parts by weight based on 100 parts by weight of a total amount of the non-aqueous organic solvent and the lithium salt.

10. The electrolyte of claim 1, wherein
a weight ratio of the first compound and the second compound is about 1:1 to about 1:20.

11. The electrolyte of claim 1, wherein
the additive of the electrolyte further comprises a third compound represented by Chemical Formula 3: 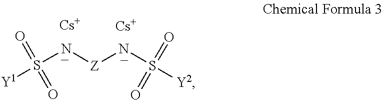
and
wherein, in Chemical Formula 3,
Z is C(═O) or S(═O)₂, and
Y¹ and Y² are each independently a fluoro group or a C1 to C5 fluoroalkyl group substituted with at least one fluoro group.

12. The electrolyte of claim 11, wherein
the third compound represented by Chemical Formula 3 is represented by any one of Chemical Formulas 3-1 to 3-8: 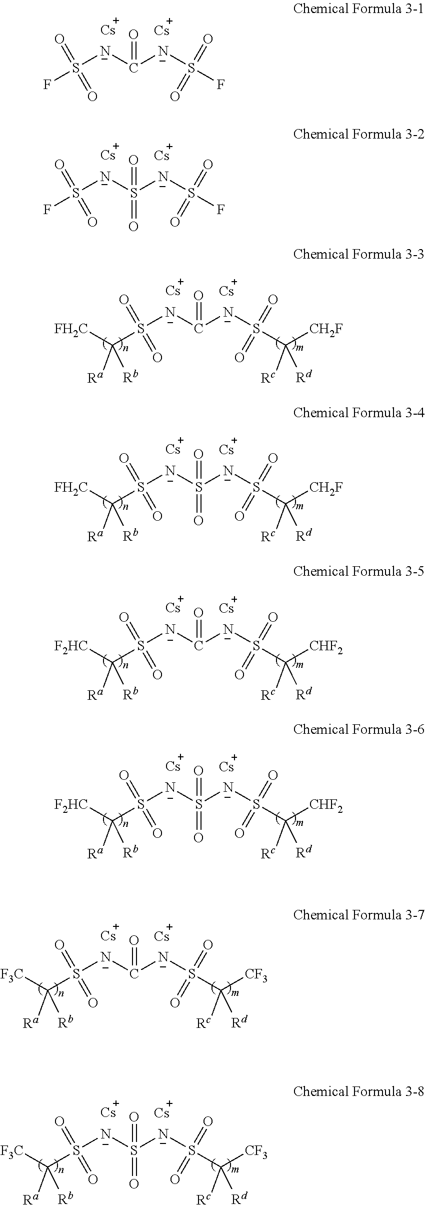
and
wherein, in Chemical Formulas 3-3 to 3-8, R^{a}, R^{b}, R^{c}, and R^{d} are each independently hydrogen or the fluoro group, and n and m are each independently an integer of 0 or 4.

13. The electrolyte of claim 11, wherein
the third compound is in an amount of about 0.01 parts by weight to about 5 parts by weight based on 100 parts by weight of a total amount of the non-aqueous organic solvent and the lithium salt.

14. The electrolyte of claim 1, wherein
the electrolyte further comprises one or more other additives, and
the one or more other additives comprise at least one selected from vinylene carbonate (VC), fluoroethylene carbonate (FEC), difluoroethylene carbonate (DFEC), chloroethylene carbonate (CEC), dichloroethylene carbonate (DCEC), bromoethylene carbonate (BEC), dibromoethylene carbonate (DBEC), nitroethylene carbonate, cyanoethylene carbonate, vinylethylene carbonate (VEC), succinonitrile (SN), adiponitrile (AN), 1,3,6-hexane tricyanide (HTCN), propene sultone (PST), propane sultone (PS), lithium tetrafluoroborate (LiBF₄), lithium difluorophosphate (LiPO₂F₂), 2-fluoro biphenyl (2-FBP), and a combination thereof.

15. The electrolyte of claim 1, wherein
in the electrolyte, the non-aqueous organic solvent comprises a carbonate-based solvent and an ester-based solvent.

16. A rechargeable lithium battery, comprising
a positive electrode comprising a positive electrode active material,
a negative electrode comprising a negative electrode active material,
a separator between the positive electrode and the negative electrode, and
the electrolyte of claim 1.

17. The rechargeable lithium battery of claim 16, wherein
the positive electrode active material comprises a lithium cobalt-based oxide.

18. The rechargeable lithium battery of claim 17, wherein
the lithium cobalt-based oxide is represented by Chemical Formula 4: 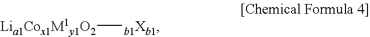
and
wherein, in Chemical Formula 4,
0.9≤a1≤1.8, 0.7≤x1≤1, 0≤y1≤0.3, 0.9≤x1+y1≤1.1, 0≤b1≤0.1,
M¹ is at least one element selected from Al, B, Ba, Ca, Ce, Cr, Cu, Fe, Mg, Mn, Mo, Ni, Se, Si, Sr, Ti, V, W, Y, Zn, and Zr, and
X is at least one element selected from F, P, and S.

19. The rechargeable lithium battery of claim 16, wherein
the positive electrode active material comprises
a first positive electrode active material comprising first particles, wherein the first particles comprise a lithium cobalt-based oxide and have an average particle diameter (D50) of about 9 μm to about 25 μm, and
a second positive electrode active material comprising second particles, wherein the second particles comprise a lithium cobalt-based oxide and have an average particle diameter (D50) of about 1 μm to about 8 μm.

20. The rechargeable lithium battery of claim 19, wherein
the first positive electrode active material is in an amount of about 60 wt % to about 90 wt %, and the second positive electrode active material is in an amount of about 10 wt % to about 40 wt %; based on a total amount of the first positive electrode active material and the second positive electrode active material.
